(19) United States
(12) Patent Application Publication
(10) Pub. No.: US 2018/0158027 A1
(43) Pub. Date: Jun. 7, 2018

(54) SYSTEM AND METHOD FOR EVALUATING A CANDIDATE CURRICULUM VITAE INTELLIGENT QUOTIENT (CVIQ) SCORE

(71) Applicant: Prasad Venigalla, Glen Head, NY (US)

(72) Inventor: Prasad Venigalla, Glen Head, NY (US)

(21) Appl. No.: 15/418,596

(22) Filed: Jan. 27, 2017

Related U.S. Application Data
(60) Provisional application No. 62/260,337, filed on Nov. 27, 2015.

(51) Int. Cl. G06Q 10/10; G06F 7/02

(52) U.S. Cl. CPC G06Q 10/1053; G06F 7/026

(57) ABSTRACT

A system and method are for performing competency evaluation of a candidate disclosed. Various embodiments provide a platform to candidates to rank their expertise based on their professional background, resume, education, communication skills, writing skills, social skills etc. Highly placed cross functional industry professionals will carry out the initial interviews with the job seekers and provide a score against each competency. The score is built based on an intelligent algorithm and is awarded to each candidate who wish to participate and take advantage of this service.

This application claims the benefit to U.S. Provisional Application No. 62/260,337, filed on Nov. 27, 2015, which application is incorporated herein by reference as if set forth in its entireties.

### FIELD OF THE INVENTION

The present invention relates generally to personnel evaluation and more particularly to a means for performing competency evaluation of a candidate.

### BACKGROUND OF THE INVENTION

As a business entity, e.g., start-up, mid-size grows, it comes a time to scale the company. When the jobs are advertised and posted on the Internet to fill the available positions, the resumes will start rolling in. Often, several hundred are received at a time and it is a daunting task for the Human Resources (HR) or hiring manager to review the resumes either manually or through an automated tool to rank the candidates. The process is time consuming and is often time sensitive to fill the position with the right candidates.

It is therefore, desirable to have a computer aided mechanism in the performance of the evaluation process of a candidate.

### SUMMARY OF THE INVENTION

Various embodiments provide a platform to candidates to score their expertise based on their professional background, resume, education, communication skills, writing skills, social skills etc. Highly placed cross functional industry professionals will carry out the initial interviews with the job seekers and provide a score against each competency. The score is built based on an intelligent algorithm and is awarded to each candidate who wish to participate and take advantage of this service.

In one embodiment, a method for evaluating a candidate CVIQ score is provided. The method comprises the steps of (a) generating a profile associated with a member candidate; (b) determining a quantitative score associated with the member candidate; (c) compiling a database of industry experts indexed according to a matrix populated with one or more attributes associated with the member candidate, the experts' qualifications and field of expertise to thereby compute a unique identifier for an evaluation session; (d) generating a profile associated with one or more experts using the unique identifier; (e) requesting a qualitative score associated with the member candidate; and (f) selecting a suitable expert to review the member candidate profile to thereby accept to conduct an interview and select relevant questions from CVIQ evaluation database; wherein an aggregated score is computed using the quantitative and qualitative factors compiled during the evaluation process.

Another embodiment provides a system, which includes a computing architecture having an input data interface engine communicatively coupled to a central processing engine, a data analytics engine, a score engine, a search engine, an output interface engine, one or more databases, said computing architecture configured to determine an aggregated score for a member candidate; and a non-transitory computer readable medium having stored thereon instructions that, upon execution by the central processing engine, cause the central processing engine to execute one or more applications associated with defining a quantitative score and a qualitative score thereby enabling an aggregate score to be computed for the member candidate to be computed and published, wherein the aggregate score is used to rank candidates.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a system benefiting from embodiments of the present invention;

FIG. 2 depicts a high-level block diagram of a computing architecture benefiting from embodiments of the present invention;

FIG. 3 depicts an exemplary computing device suitable for use in the system depicted in FIG. 2; and

FIG. 4 depicts a Flow Chart of a process for implementing the CVIQ algorithm according to an embodiment of the invention.

To facilitate understanding, identical reference numerals have been used to designate elements having substantially the same or similar structure and/or substantially the same or similar function.

### DETAILED DESCRIPTION OF THE INVENTION

Various embodiments provide a platform to candidates to score their expertise based on their professional background, resume, education, communication skills, writing skills, social skills etc. Highly placed cross functional industry professionals will carry out the initial interviews with the job seekers and provide a score against each competency. The score is built based on an intelligent algorithm and is awarded to each candidate who wish to participate and take advantage of this service.

The scores will enable the recruiters to rank or shortlist the candidate to explore further. This is pre-screening check to help the recruiters/hiring managers. Moreover, the advantages of the present embodiments are numerous namely, (1) the candidates are pre-screened based on their related industry experience to specific job requisition/industry; (2) recruiters will not be overwhelmed with hundreds of resumes to pre-screen; (3) recruiters will have the ability to search for candidate's based on score and location; (4) transparent scoring system is provided to recruiters; (5) questions and candidate responses are provided for recruiters to examine further—both in text and video files; (6) interviewed on both technical and non-technical elements against resume and job requisition; and (7) candidates will have the ability to post their indisputable score on other social networking sites to demonstrate their knowledge and practice.

The illustrative reader and processor for mobile devices system embodiments described herein are not meant to be limiting. It may be readily understood that certain aspects of the disclosed reader and processor for mobile devices system can be arranged and combined in a variety of different configurations, all of which are contemplated herein.

Generally speaking, any computing device such as a cellular telephone or smart phone or any computing device having similar functionality may implement the various embodiments described herein. In various embodiments, any Internet enabled device such as personal digital assistant (PDA), laptop, desktop, electronic book, tablets and the like capable of accessing the Internet may implement the various embodiments described herein. While computing devices are generally discussed within the context of the description, the use of any device having similar functionality is considered to be within the scope of the present embodiments.

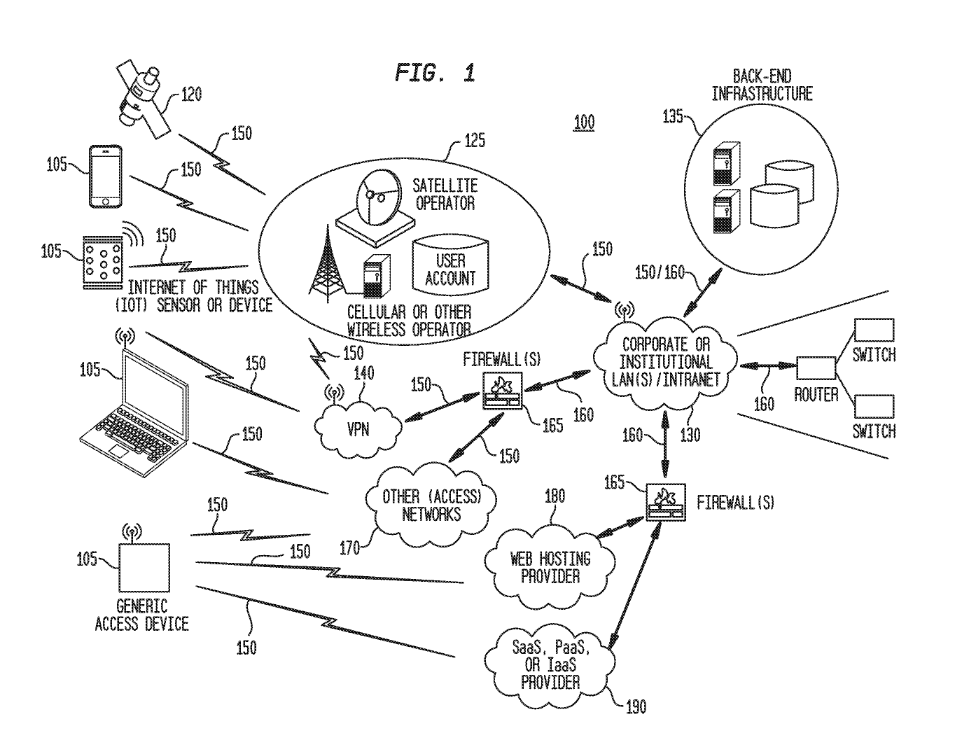

Referring now to the figures, FIG. 1 is a simplified block diagram of a CVIQ system 100, according to an exemplary embodiment herein described.

In one embodiment, the user interacts with networks 120, 125, 135, 130, 140, 170, 180, 190 via link 150/160. In one embodiment, link 150 extends over great distance and is a cable, satellite or fiber optic link, a combination of such links or any other suitable communications path. In various embodiments, link 150 extends over a short distance. In one embodiment, link 150 is a network connection between geographically distributed systems, including network connection over the Internet. In other embodiments, link 150 is wireless.

In various embodiments, device 105 is a smart phone, cellular telephone, personal digital assistant (PDA), wireless hotspot or any internet-enabled device including a desktop computer, laptop computer, tablet computer, smart watch 500, smart remote control 600 and the like capable of accessing the Internet may be used for device 105.

In various embodiments, Satellite 120 is a geo-synchronous satellite system such as global positioning system (GPS). GPS works by GPS receivers using a constellation of satellites and ground stations to compute position and time almost anywhere on earth. There are ground based stations that communicate with, the satellite network and are called the control segment. Common systems that are used by the control segment are WAAS (Wide Area Augmentation System) and DGPS (Differential Global Positioning Satellite). WAAS is the most common system, and improves accuracy to about five (5) meters. On the other hand, DGPS gets centimeter accuracy, but is very expensive. GPS data is displayed in different message formats and the type of data that is outputted is NMEA (National Marine Electronics Association) data. In one embodiment, the GPS portion of device 200 can track up to twenty two (22) satellites on sixty six (66) channels. An external UFL antenna or similar device is connected to the GPS module. In another embodiment, interactive GPS module 205 implements an ancillary geographic positioning methodology (for example, a GPS that either has the last location coordinates or has real-time location coordinates).

In one embodiment, satellite 120 is low earth orbit satellite system. In other embodiments, the use of any system having similar functionality is considered to be within the scope of the present embodiments.

In various embodiments, Cellular system 125 is a wireless infrastructure supporting cellular network functionality. In one embodiment, cellular system 125 is a small area wireless system. In other embodiments, cellular system 125 is a wide area wireless system. In other embodiments, cellular system 125 is a Wi-Fi system. In various embodiments, Cellular system 125 supports mobile services within an LTE network or portions thereof, those skilled in the art and informed by the teachings herein will realize that the various embodiments are also applicable to wireless resources associated with other types of wireless networks (e.g., 4G networks, 3G networks, 2G networks, WiMAX, etc.), wireline networks or combinations of wireless and wireline networks. Thus, the network elements, links, connectors, sites and other objects representing mobile services may identify network elements associated with other types of wireless and wireline networks. In other embodiments, the use of any wireless system having similar functionality is considered to be within the scope of the present embodiments.

In various embodiments, network 130 is an access network. In one embodiment, network 140 is a virtual private network (VPN). In other embodiments, network 130 is any network having similar functionality and as such is considered to be within the scope of the present embodiments.

Backend infrastructure 135 generally refers to infrastructure associated with the server or Host, a web server. In other embodiments, networking system 100 include additional, fewer, or different modules for various applications. Conventional components such as network interfaces, security functions, load balancers, failover servers, management and network operations consoles, and the like are not shown for better explanation of the details of the reader and processor for mobile devices system.

Web hosting provider 180 refers to the universe of hosting services, e.g., smaller hosting services, larger hosting services and host management.

SaaS (Software as a Service), PaaS (Platform as a Service) or IaaS (Infrastructure as a Service) provider 190 refers to cloud services, hosting and the like.

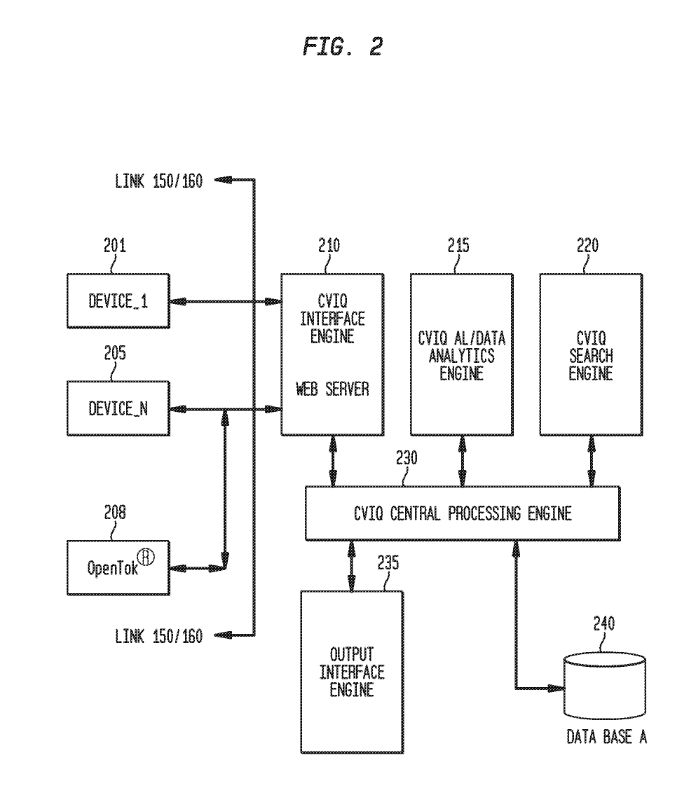

FIG. 2 depicts a high-level block diagram of a computing architecture benefiting from embodiments of the present invention. In one embodiment, computing architecture 200 is implemented in hardware. In another embodiment, computing architecture 200 is implemented in software. In yet other embodiments, computing architecture 200 is implemented as hybrid, i.e., a combination of hardware and software. Computing architecture 200 comprises CVIQ Central Processing Engine 230, which interfaces and controls CVIQ Interface Engine/Web Server 210, CVIQ AI/Data Analytics Engine 215, CVIQ Search Engine 220, CVIQ Score Engine 225, Output Interface Engine 235, Data Base A 240, Data Base B 245.

In one embodiment, computing architecture 200 comprises CVIQ Interface Engine/Web Server 210, which interfaces networks 120, 125, 135, 130, 140, 170, 180, 190, including Device 201, 205, OpenTok® 208 via link 150/160. CVIQ Interface Engine/Web Server 210 is used for initial intake and interaction with the different candidates, recruiters, industry experts/professionals and the like. CVIQ Interface Engine/Web Server 210 enables text messages, phone calls, and faxes to be completed and/or routed. These functions of computing architecture 200 work through the GSM (Global Packet Radio Service) cellular network and are controlled by AT commands, which are the data transmission that GPRS module sends. Generally, GPRS works by using the idle radio capacity created by GSM (Global System for Mobile Communications) cellular network, which is the capacity of a network provider that is not being used. A GPRS module sends data transmission through data packets through multiple paths across a GSM network. In other embodiments, CVIQ Interface Engine/W e b Server 210 is used to receive handshake or activation signals from external devices. In yet other embodiments, the native system of the device implementing computing architecture 200 is used. In other embodiments, computing architecture 200 comprises any device 105 having similar functionality and as such is considered to be within the scope of the present embodiments. Moreover, CVIQ Interface Engine/Web Server 210 is used to format and configure signals to be transmitted and received. In one embodiment, an L-band (or Ku/ka band) TX/Rx satellite link transceiver is supported. In yet other embodiments, High Throughput Satellite (HTS) services are utilized. CVIQ Interface Engine/Web Server 210 collects information such as parameters, data points, coded voice, coded video, location coordinates and other signals.

In one embodiment, computing architecture 200 comprises a CVIQ Artificial Intelligence AI/Data Analytics Engine 215, which performs data mining to (1) generate a profile for a candidate, execute the scoring algorithm, (2) generate a profile associated with one or more experts using the unique identifier, (3) respond to recruiters' request, (4)select a suitable expert to review the member candidate profile to thereby accept to conduct an interview and select relevant questions from CVIQ evaluation database and (5) alerts the industry expert/professional of a pending interview.

In some embodiments, CVIQ Artificial Intelligence AI/Data Analytics Engine 215 compiles data base of industry professionals and experts profiles. The profiles include the industry associated with expert, number of years of experience, employment history, technical skills, resume, certifications, and accomplishments. A background verification is performed for each professional/expert.

In one embodiment, computing architecture 200 comprises a CVIQ Search Engine 220, which is used to perform search requests from recruiters, industry professionals/experts, job seekers, candidates, non-member candidates and the like. In one embodiment, non-member candidates are shown only partial search results—show only industry, location, and partial job requisition. In another embodiment, interviewers have the ability to search for candidates for interview in related fields. CVIQ Search Engine 220 searches CVIQ question bank database. Searches are natural language based searches, multimedia, e.g., visual appearance (shapes, colors, etc.), search by keyword, searches can be performed in restricted natural language. In one embodiment, CVIQ Search Engine 220 includes a web search engine, a crawler, a string search engine. In one embodiment, CVIQ Search Engine 220 is a hybrid search incorporating both AI (Artificial Intelligence) and human submissions.

In one embodiment, computing architecture 200 comprises a CVIQ Score Engine 225, which is used to compute and determine both the quantitative and qualitative scores for a member candidate, compile a database of industry experts/professionals indexed according to a matrix populated with one or more attributes associated with the member candidate, the experts' qualifications and field of expertise to thereby compute a unique identifier for an evaluation session.

In one embodiment, computing architecture 200 comprises Central Processing Engine 230, which is a logical decision entity of much computational complexity manages the operations of the device. In one embodiment, Central Processing Engine 240 incorporates a real-time, multi-tasking computing entity, which executes host functions, middleware suite and operational utility host suite for the maximization and optimization of operational utility of the device. In one embodiment, the architecture of the computing entity comprises one or more processors. In other embodiment, Central Processing Engine 240 incorporates one or more vector processors in its architecture.

In one embodiment, computing architecture 200 comprises Output Interface Engine 235, which is used to format a user interface for mobile devices, CVIQ intake form, CVIQ Score Dashboard and other CVIQ documents.

In one embodiment, CVIQ Score Dashboard displays a photo of the job seeker, which is mandatory, contact information of the job seeker, job seeker's current occupation, date of the last interview, overall score, scores during the last cycles in graphical form if the job seeker interviewed multiple times to refresh the scores (providing dates of each cycle), each competency along with corresponding score. CVIQ Score Dashboard also provides the ability to track down further into each competency for members, i.e., job seekers and recruiters. Moreover, CVIQ Score Dashboard provides the questions and answers for each section (competency sub-category) and the score for each category. For example, “competency: communication skills” has two (2) sub-categories namely, writing and oratory. In this case, the score with questions and answers are provided for each subcategory. In other embodiments, the communication skills category includes multimedia presentation and the like. CVIQ Score Dashboard provides the video file (interview) on the dashboard. The video file is not downloadable, but can be viewed on the dashboard. There is no expiry of the score, but the last interviewed date must be displayed. CVIQ Score Dashboard provides comparative analysis based on the score with other candidates in related field. The candidate is graded against a defined scale and the grade report including all the specifics, both positives & negatives and areas to improve. It may also include the key areas covered in the interview at a high level along with the interviewer's comments. In the event the candidate is not satisfied with his/her grade, he will be given up to 2 more chances for re-evaluation (Each time by an evaluator with a higher rating than the last time). After the first re-evaluation, the best of the two will be considered as the candidate's grade. After the second or final re-evaluation, the average of the best of (2) two (out of 3) will be considered as the final grade to reduce the variance.

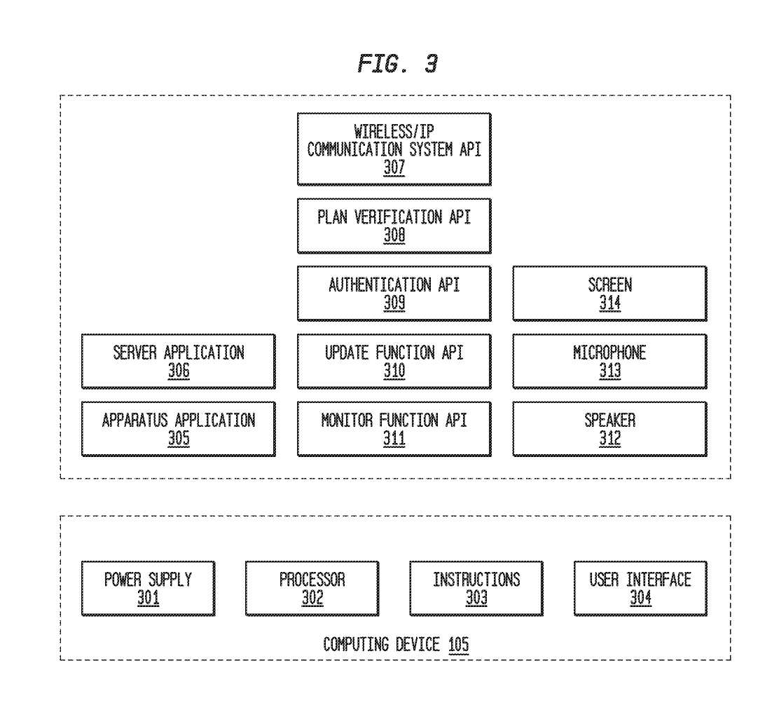

FIG. 3 depicts an exemplary computing device suitable for use in the architecture depicted in FIG. 2. Computing device 105 may include power supplies 301, a processor 302, and a memory 303 for storing instructions and the like, a user interface 304. Power supply 301 provides power to computing device 105. As such, the power supply may include, for example backup batteries. Other power supply configurations are possible as well. Processor 302 included in computing devices 105 may comprise one or more general-purpose processors and/or o ne or more special-purpose processors (e.g., image processor, digital signal processor, vector processor, etc.). To the extent that computing device 105 includes more than one processor, such processors could work separately or in combination. Computing device 105 may be configured to control functions of reader and processor for mobile devices system 100 based on input received from one or more clients via user interface 304, for example.

Memory 303 may comprise one or more volatile and/or nonvolatile storage components such as optical, magnetic, and/or organic storage and memory 303 may be integrated in whole or in part with computing device 105. Memory 303 may contain instructions (e.g., applications programming interface, configuration data) executed by processor 302 in performing various functions of reader and processor for mobile devices system 100, including any of the functions or methods described herein. Memory 303 may further include instructions executable by processor 302 to control and/or communicate with the additional components.

Peripherals may include speaker 314, microphone 313 and screen 316. Speaker 314 may be configured to output audio to the user of reader and processor for mobile devices system 100.

Similarly microphone 315 may be configured to receive audio from a user of reader and processor for mobile devices system 100. Screen 316 may comprise one or more devices used for displaying information to the user of computing device 105. Screen 316 may comprise a touchscreen used by a user to input commands to computing device 105. As such, a touchscreen may be configured to sense at least one of a position in the movement of a user's finger via capacitive sensing, or a surface acoustic wave process among other possibilities. Generally, a touchscreen may be capable of sensing finger movement in a direction parallel or perpendicular to the touchscreen surface of both, and may also be capable of sensing a level of pressure applied to the touchscreen surface. A touchscreen comes in different shapes and forms.

Computing device 105 may include one or more elements in addition to or instead of those shown.

In various embodiments, APIs are used for transferring data from Server application 306) to Apparatus application 305. Although depicted and described with respect to the aforementioned APIs, it will be appreciated by those skilled in the art that other APIs having similar functionality are considered to be within the scope of the present embodiments.

In one embodiment, APIs (308, 309, and 310) are used for passing Email and password parameters from Apparatus application 305 to Server application 306 and used to validate the login of the user.

In one embodiment, APIs (307, 308, 309, and 310) transfer Email parameters from Apparatus application 305 to Server application 306 and new password is sent to users email.

Generally speaking, device 105 includes any Internet enabled device such as personal digital assistant (PDA), laptop, desktop, electronic book, tablets and the like capable of accessing the Internet may implement the various embodiments described herein. While apparatus 105 is generally discussed within the context of the description, the use of any device having similar functionality is considered to be within the scope of the present embodiments.

Although depicted and described with respect to an embodiment in which each of the APIs, engines, databases, and tools is stored within memory 303, it will be appreciated by those skilled in the art that the APIs, engines, database, and/or tools may be stored in one or more other storage devices external to computing device 105.

The APIs, engines and tools may be activated in any suitable manner. In one embodiment, for example, the APIs, engines and tools may be activated in response to manual requests initiated by a user, in response to automated requests initiated by computing device 105, or other devices and the like, as well as various combinations thereof. For example, where an engine or tool is activated automatically, the engine or tool may be activated in response to scheduled requests, in response to requests initiated by computing device 105 based on processing performed at computing device 105.

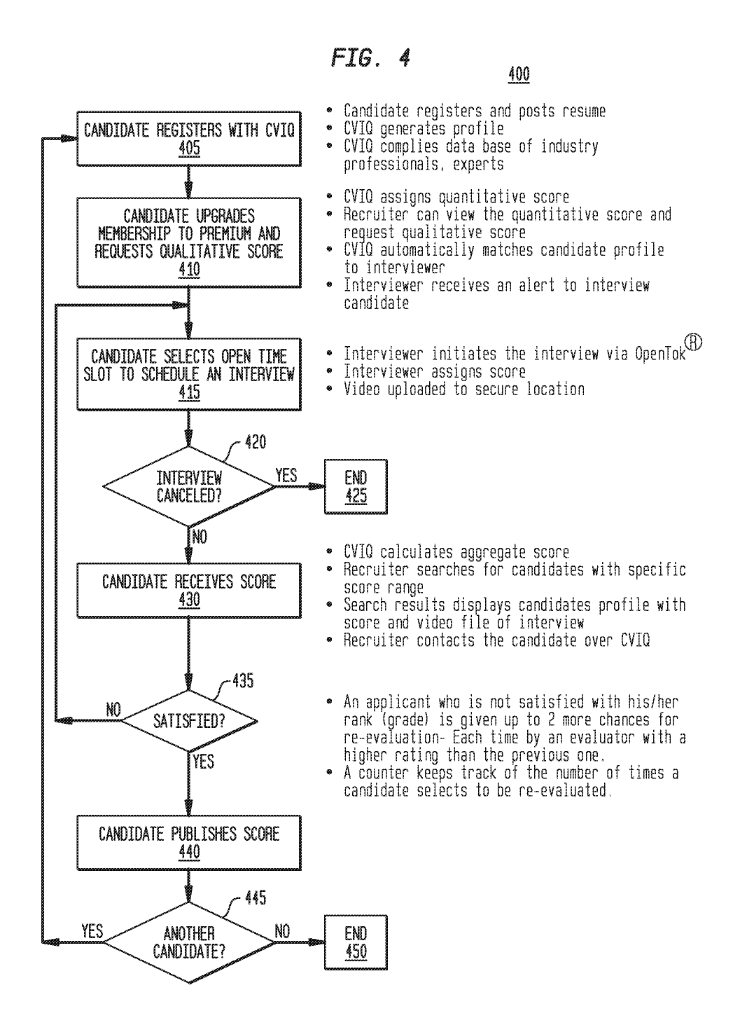

FIG. 4 depicts a Flow Chart of a process for implementing CVIQ algorithm according to an embodiment of the invention.

At step 405, a user accesses the CVIQ system; the user registers and posts his/her resume. The user must register with basic info—experience, educational background, location preference, relocation preference, employment history, accomplishment, preferred job, current job. These are the minimum requirements to register as a candidate. The resumes and scores will be stored in a central database by candidates unique ID. Email ID is maintained as unique log-in ID for account creation. The candidate has the ability to “copy & paste” their resume on the site in a pre-defined format. This is in addition to uploading the resume. The candidate has the ability to specify their own keywords, e.g., Certified Java, PMP, CISM, CISSP). The will help the recruiters to do a key word search against the database to explore the candidates. The candidate has the ability to upload certificates or job related documents (jpg, PNG or any other suitable format). CVIQ then generates a profile of the registered candidate. The candidates have the ability to perform a job search (free or paid) by location/industry/technical skills, etc. The candidate is unable to post the resume against a job requisition unless the candidate is a paid member. In one embodiment, candidates offer freelance services through CVIQ. In other embodiments, candidates can create job alerts to receive new postings.

In other embodiments, when a registered candidate subsequently accesses the system, the member-candidate is identified using fingerprint recognition, iris recognition or password and authenticated.

At step 410, a candidate upgrades to premium membership. CVIQ assigns a quantitative score to the candidate as a result of the candidate's resumes being evaluated and rated based on basic articulation and overall integrity. In one embodiment, the quantitative score is computed using a scale of 500-1000 as follows:

Quantitative Score=A+B+C+D+E

where A=Experience+Professional Background;
B=Education;
C=Certifications;
D=Awards and Accomplishments; and
E=Publications and Patents.

In one embodiment, each element is weighted according to CVIQ defined scale of 500. In other embodiments, a sliding scale is used. In yet other embodiments a fixed scale is used. As such, A has a nominal graded weight of 0-60%. For example, using 30% as a weight on a scale of 500 for Experience would result in the following points being accorded to A:

<1 year of experience: 0 Points

1-2 years of experience: 30 Points

2-5years of experience: 75 Points

5-10 years of experience: 105 Points

10-15 years of experience: 135 Points

>15 Years of experience: 150 Points;

B has a nominal graded weight of 0-60%. For example, using 30% as a weight on a scale of 500 for Education would result in the following points being accorded to B:

Doctorate Degree: 150 Points

Masters Degree: 105 Points

Bachelor's Degree: 75 Points

Associate Degree: 50 Points

High School: 25 Points

C has a nominal graded weight of 0-30%. For example, using 15% as a weight on a scale of 500 for Certifications would result in 75 points being accorded to C. In one embodiment, a candidate is allowed a maximum of eight (8) certifications where in the foregoing example each certification is accorded 9.375 points. In other embodiments, C varies according to the weighted percentage used.

D has a nominal graded weight of 0-30%. For example, using 15% as a weight on a scale of 500 for Awards and Accomplishments would result in the following points being accorded to D:

0-2 Awards: 5 Points

2-5 Awards: 10 Points

5-10 Awards: 25 Points

10-15 Awards: 35 Points

15 Awards: 75 Points;

and E has a nominal graded weight of 0-20%. For example, using 10% as a weight on a scale of 500 for Patents and Publications would result to 50 points being accorded to E. In one embodiment, a candidate is allowed a maximum of ten (10) Patents such that in the foregoing example each Patent is accorded 5 points. In other embodiments, E varies according to the weighted percentage used.

In other embodiments, the weights are reversed. In yet other embodiments, the weights are interchanged. In some embodiments, other competencies are evaluated based on interviewer and specific to job industry. Each competency has its own question bank maintained by the interviewer. The interviewer must maintain question bank to the minimum to add up to the assigned scale (for example 500). In some embodiments, the Recruiters have the option to generate CVIQ score by altering the weight of one or more elements (A, B, C, D, E) or qualitative score weight to one or more areas.

A recruiter can view the quantitative score and request a qualitative score when available. A recruiter who is a paid member can search the candidate database and view the score details such as overall score, by competency including questions and corresponding answers, Date & Time Stamp last interviewed, view the certifications (scanned docs), download the resume in PDF format, details about the interviewer and view performance based recommendations from other colleagues. Paid recruiter has the ability to contact the job seeker directly, perform, candidate search by keyword, location, job titles, industry, score and the like, post a job requisition. Recruiters have the ability to view a list of proposed potential candidates against their job postings and create alerts to receive postings or messages when job seekers post their resume or attained a high threshold score against a specific role/technical skills.

In one embodiment, the companies have the ability to leverage the service to interview their candidates preliminarily. The final score is emailed to the company representative along with the questions & answers with individual rating.

Having upgraded to premium membership, the member candidate is able to request a qualitative score, which is obtained after the candidate is evaluated through an interview. In one embodiment, the interview is performed via video. The video interviews will be recorded and posted on the candidate's profile. In other embodiment, the interview is performed in-person. The candidate is interviewed typically for 60-90 (3 different interviews) minutes over a video call. During this time, the candidate is evaluated on the fundamental knowledge of basics in various key areas of the respective technology, overall real-time hands on experience, along with the basic communication skills and professional integrity.

CVIQ automatically matches the candidate profile to a suitable interviewer. In one embodiment, a suitable interviewer is not from the same location as the candidate, has similar skill sets in similar industry and has more than three (3) years experience as the candidate. An interviewer meeting the above criteria can be a freelancer, a CVIQ staff, an agent of the recruiter or an agent of the employer. An interviewer has the ability to create alerts to receive postings when matching candidates post their resume to be interviewed.

Next, the chosen interviewer receives an alert to interview the candidate. The interviewer reviews the candidate's profile and accepts to perform the interview. The candidate who has been contacted first by the interviewer has priority. The interview will be scheduled upon mutual agreement between candidate and interviewer. CVIQ provides the infrastructure to maintain a question bank for the interviewers and create a workspace for each interviewer to maintain their question bank for each competency. For example, question bank for technical skills is different from Communication skills or social skills. The question bank is personalize for each interviewer, cannot be shared. Post interview, the details are published along with video file, Q & A's etc. no further edits are allowed. Furthermore, CVIQ's infrastructure allows an interviewer to key in the answers for corresponding questions. Interviewers' contact information are published on the candidates dashboard. Interviewers must be prepared to interview the candidate from 60-90 minutes. Interviewers are not allowed to interview same candidate twice. Interviewers must adhere to CVIQ standards & procedures while interviewing the candidates. Candidates have the ability to rate the interviewers and provide feedback, download interviewer's resume from the candidate's profile. It is entirely up to the interviewer's discretion to award the final points. Any dispute between the interviewer and the job seeker will be brought up to the CVIQ team for resolution. Interviewers are rated by candidate based on their experience, history, interview skills etc. and are highlighted as top performers on the site.

Interviewers have the ability to provide feedback to the candidate post interview, sort of summary for the recruiter. The candidate has the option to share the overall summary or recommendation on their personal dashboard. Interviewers are expected to have good communication skills, sound technical skills and considerable amount of experience in the relevant fields (ideally, 8+ years). Interviewers will go through CVIQ's training programs to carry out evaluation as per the defined standards for accurate grading. Interviewers will be rated for every three (3) months and paid as per their rating. There will be three (3) different levels of evaluators and rating is the basis for deciding the level.

At step 415, the candidate selects an open time slot to schedule the interview. The candidate receives an alert and checks the interview time slot. The

interviewer confirms the time slot and initiates the interview at the scheduled time. In one embodiment, the interview is held over OpenTok®. In other embodiments, other suitable infrastructure is used. The interviewer is chosen among CVIQ staff, Freelancer, Recruiter unless HR (Human resources) sets preferences set by job postings. In this case, HR opens its calendar for the candidate to pick an open slot. As a result, a “confirmation” or “invite” is sent by the recruiting agent, HR, CVIQ, Freelancer. The interviewer rates the candidate based on the candidate's answers to questions posed. The interviewer's scoring must fall within the range provided for each of the qualitative areas and CVIQ system, calculates the final qualitative score based on percent (%) weight assigned to each area.

The questions are framed by the interviewer based on the below scoring guidelines. The Database of questions are pooled from the Recruiters, CVIQ, Freelance Interviewer and CVIQ system sorts the specific questions for the candidate to answer during the video interview. In one embodiment, the scoring guidelines can be altered by the interviewer based on the industry & candidates background. For example, a developer may not need to have leadership skills but development skills. So the interviewer can alter the scoring mechanism by applying N/A or opt-out in the leadership category and increase the rating in other areas. The key aspect is that the interviewer must have the flexibility to align the scoring based on the candidate background. The interviewer can utilize the CVIQ question bank as needed. The guideline is that the interviewer must determine, evaluate and add questions prior to the interview. The interviewer has the ability to add text based answer (max: 5000 words, and Yes/No questions to the question bank.

The total score is based on 1080-2160 points distributed as follows:

SME & background: 0-60%;

Social Skills & Situational & Empathy: 0-60%;

Leadership and Management: 0-60%;

Communication: 0-60%.

For example, using the scale of 1080 points, a candidate is ranked as poor if the score is 0-249; fair if the score is 250-449; good if the score is 450-649; excellent if the score is 649-849; and CVIQ premium candidate if the score is 850 and above. After the interview, the video is uploaded to a secure location. A unique ID associated with the video is provided to the candidate. Subsequently, the interviewer assigns the score. In one embodiment, each element is weighted according to CVIQ defined scale of 1080-2160. In other embodiments, a sliding scale is used. In yet other embodiments a fixed scale is used.

At step 420, if it's determined that the interview was cancelled, then the process ends at step 425. Otherwise, step 430 is executed.

At step 430, CVIQ calculates the aggregate score by adding the quantitative and qualitative scores together. In one embodiment, the aggregate score has a nominal graded of 50%. For example, if the quantitative score is 50, then the qualitative score would also be 50. In other embodiments, a sliding scale is used. In yet other embodiments a fixed scale is used.

The candidate receives the score. The recruiter has the ability to search for candidates with specific score range. The search result is displayed showing the candidate's profile along with the score and the video file of the interview.

At step 435, if the candidate is satisfied with his/her score, step 440 is executed, otherwise the candidate is given up to chances for re-evaluation; each time by an evaluator with a higher rating than the previous one. In one embodiment, after the first re-evaluation the best of the two scores is kept, as the candidate's score. In another embodiment, after the second and final re-evaluation, the average of the best of (2) two out of three (3) scores will be considered as the final grade to reduce the variance. A counter keeps track of the number of times a candidate selects to be re-evaluated.

At step 440, the candidate publishes the aggregated score on the CVIQ profile and optionally on other social networking sites.

At step 445, if it's determined there is no other candidate, the process ends at step 450. Otherwise, the process loops back to step 405.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the sub-stance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore 65 intended that the scope of the invention be limited not by this detailed description, but rather by any claims that issue on an application based hereon.

Although various embodiments which incorporate the teachings of the present invention have been shown and described in detail herein, those skilled in the art can readily devise many other varied embodiments that still incorporate these teachings

We Claim:

1. A method for evaluating a candidate CVIQ score comprising:
(a) generating a profile associated with a member candidate;
(b) determining a quantitative score associated with the member candidate;
(c) compiling a database of industry experts indexed according to a matrix populated with, one or more attributes associated with the member candidate, the experts' qualifications and field of expertise to thereby compute a unique identifier for an evaluation session;
(d) generating a profile associated with one or more experts using the unique identifier;
(e) requesting a qualitative score associated with the member candidate; and
(f) selecting a suitable expert to review the member candidate profile to thereby accept to conduct an interview and select relevant questions from CVIQ evaluation database;
wherein an aggregated score is computed using the quantitative and qualitative factors compiled during the evaluation process.

2. The method of claim 1, wherein the member profile is generated using the member candidate's intake.

3. The method of claim 1, wherein the member candidate provides a minimum number of core competencies.

4. The method of claim 3, wherein the minimum number of core competencies include qualifications and skills such as number of years of professional experience, certifications, awards and accomplishments, patents and education.

5. The method of claim 1, wherein the maximum quantitative score of 500 is computed using the minimum number of qualifications and skills.

6. The method of claim 1, wherein the evaluation session includes one or more interviews.

7. The method of claim 6, wherein the one or more interviews are conducted over one of audio, video.

8. The method of claim 1, wherein the member candidate upgrades to premium membership to facilitate requesting the qualitative score.

9. The method of claim 1, wherein the request of the qualitative score triggers the interview process.

10. The method of claim 9, wherein the expert who is appointed interviewer receives an alert to interview the member candidate.

11. A system comprising:
a computing architecture having an input, data interface engine communicatively coupled to a central processing engine, a data analytics engine, a score engine, a search engine, an output interface engine, one or more databases, said computing architecture configured to determine an aggregated score for a member candidate; and
a non-transitory computer readable medium having stored
thereon instructions that, upon execution by the central processing engine, cause the central processing engine to execute one or more applications associated with defining a quantitative score and a qualitative score thereby enabling an aggregate score to be computed for the member candidate to be computed and published,
wherein the aggregate score is used to rank candidates.

12. The system of claim 11, wherein the computing architecture comprises a server or host communicatively coupled to the cloud, said server propagates configuration data towards the central processing unit, thereby enabling said at least central processing unit to interact with the plurality of engines to exchange a plurality of data points with at least one engine for use in computing the aggregate score.

13. The system of claim 11, wherein the cloud comprises a social network, a virtual private network (VPN), a wide area network (WAN), a local area network (LAN), corporate LAN, the Internet, satellite communication network, cellular network.

14. The system of claim 11, wherein the central processing unit further comprises:
a non-transitory computer readable medium having stored thereon instructions that, upon execution by the central processing unit, cause the central processing unit to
perform a method comprising:
(a) generating a profile associated with a member candidate;
(b) determining a quantitative score associated with the member candidate;
(c) compiling a database of industry experts indexed according to a matrix populated with one or more attributes associated with the member candidate, the experts' qualifications and field of expertise to thereby compute a unique identifier for an evaluation session;
(d) generating a profile associated with one or more experts using the unique identifier;
(e) requesting a qualitative score associated with the member candidate; and
(f) selecting a suitable expert to review the member candidate profile to thereby accept to conduct an interview and select relevant questions from CVIQ evaluation database;
wherein an aggregated score is computed using the quantitative and qualitative factors compiled during the evaluation process.
